(19) United States
(12) Patent Application Publication
(10) Pub. No.: US 2004/0003492 A1
(43) Pub. Date: Jan. 8, 2004

(54) Method for winding transformers

(76) Inventor: Chi-Chih Wu, Taipei (TW)

Correspondence Address: BIRCH STEWART KOLASCH & BIRCH, PO BOX 747, FALLS CHURCH, VA, 22040-0747, US

(21) Appl. No.: 10/186,720

(22) Filed: Jul. 2, 2002

(51) Int. Cl. H01F 7/06

(52) U.S. Cl. 29/602.1; 29/605; 29/606

(57) ABSTRACT

A method for winding transformers is adopted for use on Sub-miniature Tube Transformers. The transformer includes a winding shaft which has a winding zone. At least one layer of primary coil is wound on the winding zone, and a first insulation layer is covered on the wound primary coil. Then a plurality of layers of secondary coils are wound on the first insulation layer. Each layer of the secondary coils is covered by a second insulation layer, thus short circuit resulting from peeling off of the lacquer on the copper wires during winding the secondary coils can be avoided, and electric output characteristics of the transformer are improved, and the reliability and quality of the transformer are enhanced.

### FIELD OF THE INVENTION

The present invention relates to a method for winding transformers and particularly a method for preventing short circuit caused by peeling off of lacquer on the coils during winding secondary coils.

### BACKGROUND OF THE INVENTION

The presently known transformers generally consist of a winding shaft, coils wound on the winding shaft, an iron core located in the winding shaft and a shell encasing the winding shaft and the iron core. The coils wound on the winding shaft include a primary coil and secondary coils. For winding the primary coil and the secondary coils, first, the primary coil is wound in a primary coil trough. After winding of the primary coil is finished, the secondary coils are wound on the same winding shaft. As the secondary voltage is higher, the secondary coils have a greater number of coils.

Conventional transformers (as shown in FIG. 1) generally adopt multiple troughs for the winding shaft of the secondary coils. Such a design often results in irregular laying of copper wires in the same trough during winding the secondary coils. As a result, electric potential difference becomes greater between the copper wires. In addition, the copper wires have relatively poor insulation (cavities, scratches, etc) and are prone to cause short circuit and affect electric output characteristics. Consequently, the reliability and quality of the transformer could be adversely impacted.

### SUMMARY OF THE INVENTION

Therefore the primary object of the invention is to resolve aforesaid disadvantages. The invention aims at winding copper wires by layers. When winding of the secondary coils is finished, the copper wires of every coil are evenly and neatly laid with a smaller electric potential difference between the copper wires. Every layer of the copper wires is isolated by a covering insulation film. Thus short circuit is unlikely to take place, and output electric characteristics of the transformer can be maintained as desired. As a result, the reliability and quality of the transformer can be enhanced.

In order to achieve the object set forth above, in the method of the invention at least one layer of primary coil is wound on the bottom layer of the winding zone of the wining shaft. After winding of the primary coil is finished, a first insulation layer is covered on the primary coil. Then a plurality of layers of secondary coils are wound on the first insulation layer. Every layer of the secondary coils is covered by a second insulation layer. Or the winding shaft has two winding zones with at least one layer of primary coil wound on one winding zone and a plurality of secondary coils wound on other winding zone. And every layer of the secondary coils is covered by a second insulation layer.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a winding shaft of a conventional transformer.

FIG. 2 is an exploded view of a transformer of the invention.

FIG. 3A is a side view of a transformer of the invention.

FIG. 3B is a cross section taken along line 3B-3B in FIG. 3A.

FIG. 3C is a fragmentary enlarged view according to FIG. 3B.

FIG. 4A is a schematic view of another embodiment of a transformer winding shaft according to the invention.

FIG. 4B is a cross section taken along line 4B-4B in FIG. 4A.

FIG. 4C is a fragmentary enlarged view according to FIG. 4B.

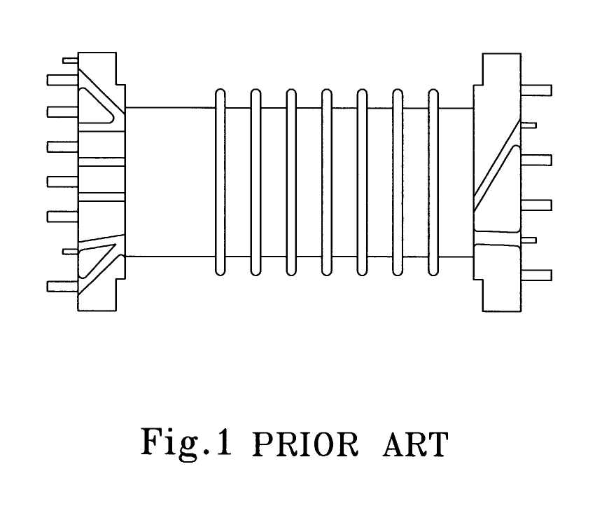

### DESCRIPTION OF THE PREFERRED EMBODIMENTS

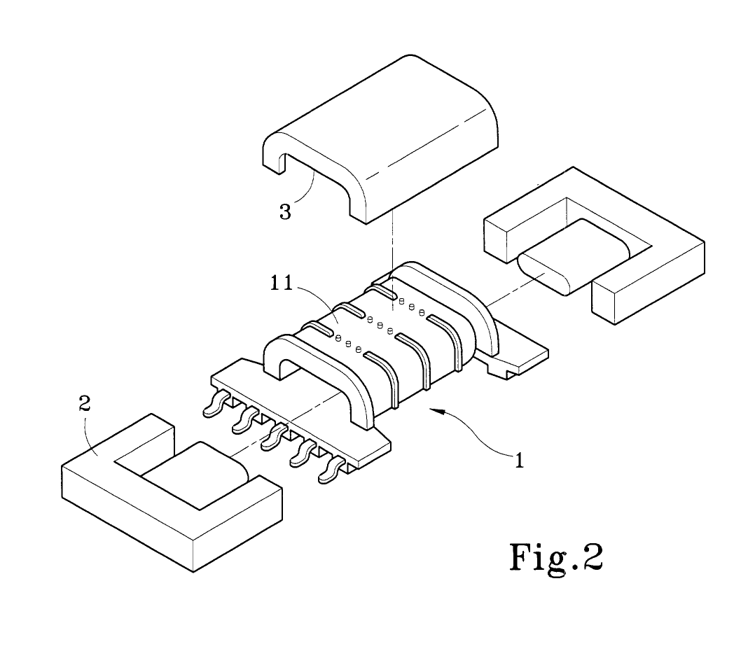

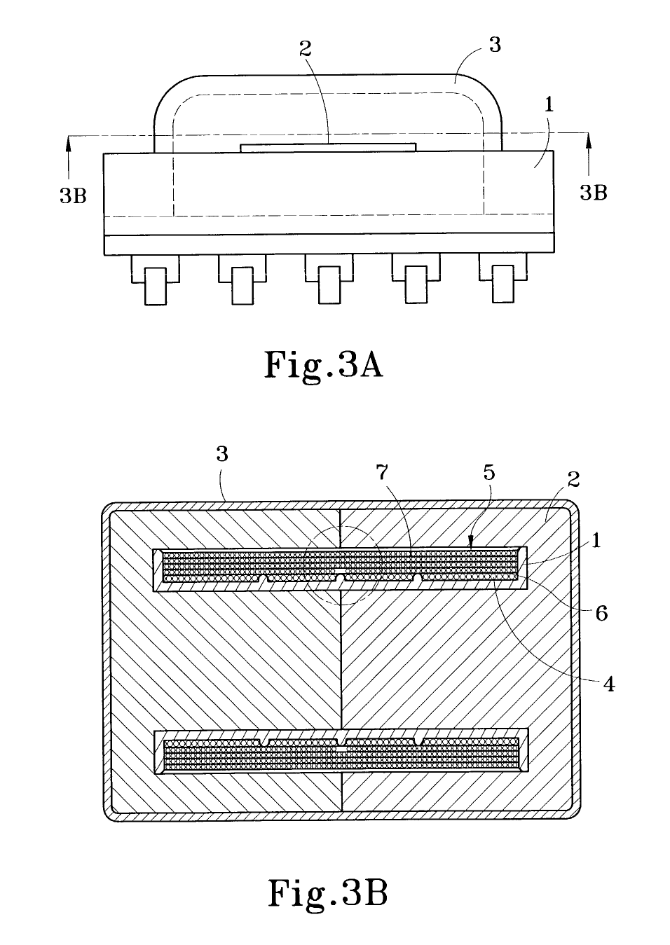

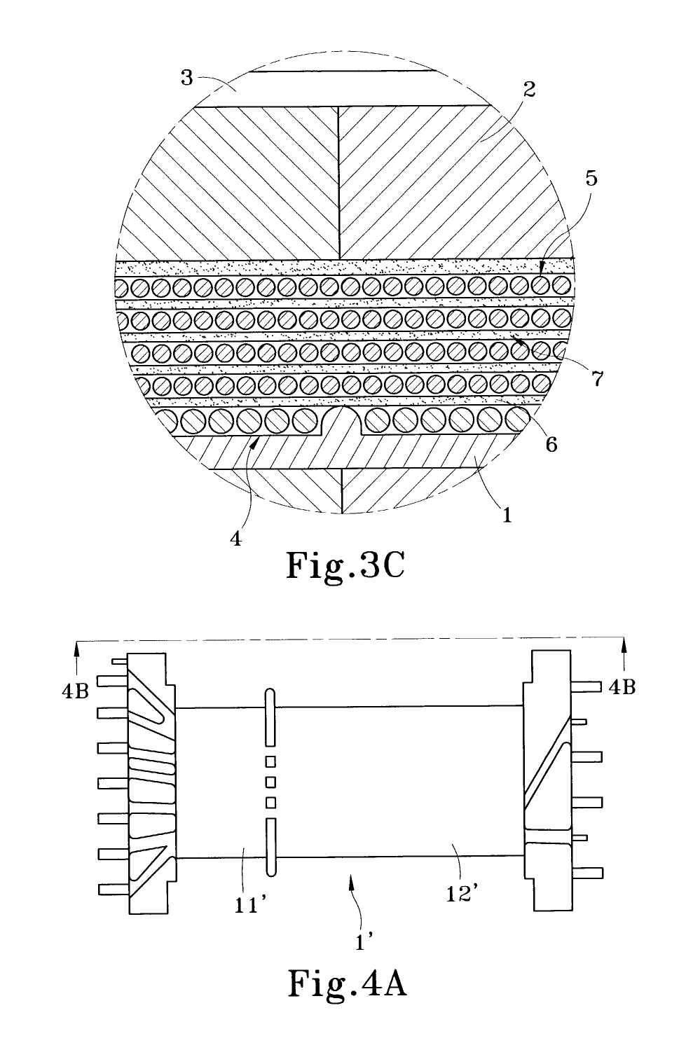

Refer to FIGS. 2 and 3A for a transformer according to the invention. The winding method of the invention is adopted for use on Sub-miniature Tube Transformers. The transformer includes at least a winding shaft 1, an iron core 2 located in winding shaft 1, and a shell 3 to encase the winding shaft 1 and the iron core 2. The winding shaft 1 has a winding zone 11 for winding coils (not shown in the drawings). The winding zone 11 has two sides each has a connection section 12 communicating with each other. The connection sections 12 may connect the iron core 2. After the winding shaft 1 and the iron core 2 are coupled, they are encased in the shell 3 to form a transformer to output electric power.

Referring to FIGS. 3B and 3C, the winding zone 11 of the winding shaft 1 may be wound by enameled wires (copper wires coated with lacquer) of the same or different diameters to form a primary coil 4 and secondary coils 5.

For winding the primary coil 4 and the secondary coils 5, first, wind at least one layer of the primary coil 4 on the bottom layer of the winding zone 11. After winding of the primary coil 4 is finished, cover the primary coil 4 with a first insulation layer 6 made from an insulation film. After the first insulation layer 6 is in place, wind a plurality of layers of the secondary coils 5 on the first insulation layer 6. Each layer of the secondary coils 5 is covered by a secondary insulation layer 7 made from an insulation film. The winding method for the secondary coils 5 set forth above is to prevent the lacquer from peeling off the copper wires during winding process, and to avoid the copper wires in contact with one another in the secondary coils 5 and result in short circuit. Therefore electric output characteristics of the transformer can be improved, and the reliability and quality of the transformer can be enhanced.

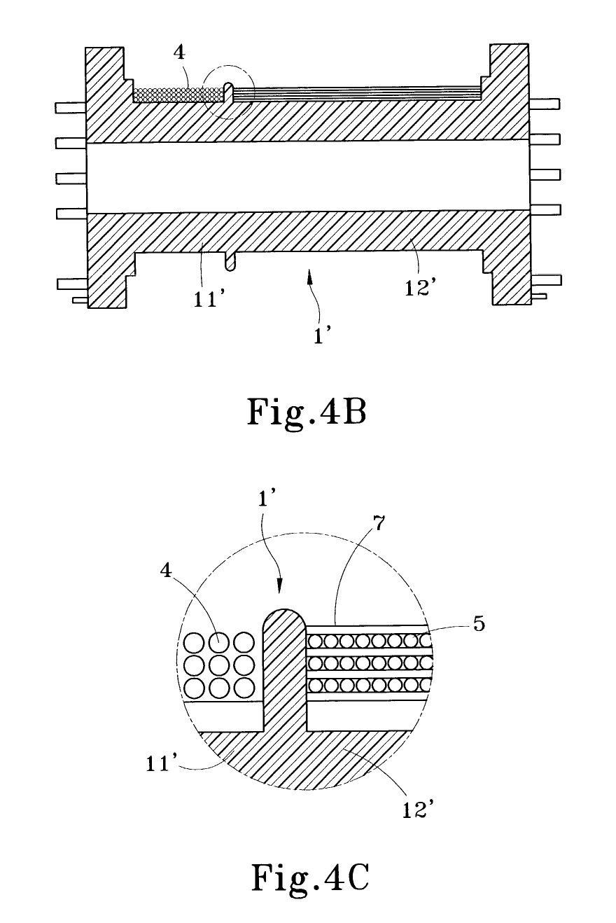

Refer to FIG. 4A for another embodiment of the invention. As shown in the drawing, the winding shaft 1′ is largely same as the winding shaft 1 set forth above. The main difference is that the winding shaft 1′ has a first winding zone 11′ and a second winding zone 12′ of the same or different sizes. The first winding zone 11′ is for winding the primary coil (not shown in the drawing), while the second winding zone 12′ is for winding the secondary coils (also not shown in the drawing).

Referring to FIGS. 4B and 4C, for winding the coils on the winding shaft 1′, at least one layer of the primary coil 4 is wound on the first winding zone 11′ while at least one layer of the secondary coil 5 is wound on the second winding zone 12′. Each layer of the secondary coil 5 is covered by a secondary insulation layer 7 made from an insulation film. The insulation layer 7 can prevent the lacquer from peeling off the copper wires of the secondary coil 5 and resulting in contact of the copper wires and cause short circuit. By adopting different winding zones 11′ and 12′ for winding the primary coil 4 and the secondary coil 5, the first insulation layer 6 may be saved. Thus production processes, time and cost may be reduced.

In addition, the method of winding the transformer of the invention winds copper wires in a layer fashion. When winding of the secondary coils is finished, copper wires on each coil is laid evenly and neatly. Electric potential difference between the copper wires is smaller. As each layer of copper wires is covered by an insulation film for isolation, short circuit may be prevented. Output electric characteristics of the transformer is improved, and the reliability and quality of the transformer are enhanced.

What is claimed is:

1. A method for winding a transformer which has a winding shaft with a winding zone formed thereon for winding a primary coil and a secondary coil, comprising the steps of:
winding at least one layer of the primary coil on a bottom layer of the winding zone, and covering a first insulation layer on the wound primary coil; and
winding a plurality of layers of the secondary coil on the first insulation layer, and covering each layer of the secondary coil with a second insulation layer.

2. The method of claim 1, wherein the primary coil and the secondary coil are formed by enameled wires.

3. The method of claim 1, wherein the primary coil and the secondary coil have same or different diameters.

4. The method of claim 1, wherein the first insulation layer is made from an insulation film.

5. The method of claim 1, wherein the second insulation layer is made from an insulation film.

6. A method for winding a transformer which has a winding shaft consisting of two winding zone for winding a primary coil and a secondary coil, comprising the steps of:
winding at least one layer of the primary coil on one winding zone; and
winding a plurality of layers of the secondary coil on other winding zone, and covering each layer of the secondary coil with a second insulation layer.

7. The method of claim 6, wherein the two winding zones are of the same size or different sizes.
